(19) United States
(12) Patent Application Publication
(10) Pub. No.: US 2024/0412190 A1
(43) Pub. Date: Dec. 12, 2024

(54) INFORMATION PROCESSING APPARATUS, INFORMATION PROCESSING METHOD, AND PROGRAM

(71) Applicant: Sony Group Corporation, Tokyo (JP)

(72) Inventors: Yusaku MAEDA, Tokyo (JP); Shinya MARUYAMA, Kanagawa (JP)

(73) Assignee: Sony Group Corporation, Tokyo (JP)

(21) Appl. No.: 18/698,798

(22) PCT Filed: Sep. 12, 2022
(86) PCT No.: PCT/JP2022/033998

§ 371 Date: Apr. 5, 2024

(30) Foreign Application Priority Data
Nov. 4, 2021 (JP) 2021-180271

(51) Int. Cl. G06Q 20/22

(52) U.S. Cl. CPC G06Q 20/223

(57) ABSTRACT

An information processing apparatus according to an embodiment of the present technology includes a transmitter and an executer. The transmitter sends, to a blockchain, contract information related to a payer who pays a predetermined payment amount and a receiver who receives the predetermined payment amount, the contract information having been encrypted. The executer automatically executes payment on the basis of the contract information. Accordingly, the payment can be automatically performed while protecting privacy of the contract information managed by the blockchain. Moreover, it is possible to flexibly cope with various use cases by using functions of the blockchain and the smart contract with privacy protected.

### TECHNICAL FIELD

The present technology relates to an information processing apparatus, an information processing method, and a program that can be applied to payment based on a contract or the like.

### BACKGROUND ART

Patent Literature 1 has described a post processing method based on copyright registration information in which participant information and post processing information are acquired on the basis of the copyright registration information. In this post processing method based on the copyright registration information, the participant information and the post processing information are sent in a blockchain network as a transaction request and added to and stored in a block (Paragraphs [0018] to [0033] in the specification, FIG. 1, etc. in Patent Literature 1).

Patent Literature 2 has described a revenue allocation system that manages various types of information on ownership of target products in transactions generated in commercial distribution of products produced by primary sector workers, the commercial distribution starting from the primary sector workers, and credits transferred between those related to the transactions. In this revenue allocation system, by transferring ownership of delivered products associated with a predetermined transaction in the commercial distribution to a predetermined broker, purchase processing of a dept in the predetermined transaction, with the broker as a buyer, is executed, and payment processing corresponding to a difference in value between the dept held by the broker through the purchase processing to a creditor in the predetermined transaction and the credit held for the creditor is executed (Paragraphs [0014] to [0028] in the specification, FIGS. 1 and 2, etc. in Patent Literature 2).

### CITATION LIST

### Patent Literature

Patent Literature 1: Japanese Unexamined Patent Application Publication No. 2021-500811
Patent Literature 2: Japanese Patent Application Laid-open No. 2019-49930

### DISCLOSURE OF INVENTION

### Technical Problem

In such payment based on a contract, it is desirable to provide a technology that enables privacy protection to be achieved.

In view of the above-mentioned circumstances, it is an objective of the present technology to provide an information processing apparatus, an information processing method, and a program that enable privacy protection to be achieved.

### Solution to Problem

In order to accomplish the above-mentioned objective, an information processing apparatus according to an embodiment of the present technology includes a transmitter and an executer.

The transmitter sends, to a blockchain, contract information related to a payer who pays a predetermined payment amount and a receiver who receives the predetermined payment amount, the contract information having been encrypted.

The executer automatically executes payment on the basis of the contract information.

In this information processing apparatus, the contract information related to the payer who pays the predetermined payment amount and the receiver who receives the predetermined payment amount, which has been encrypted, is sent to the blockchain. On the basis of the contract information, the payment is automatically executed. Accordingly, the payment can be automatically performed while protecting privacy of the contract information managed by the blockchain.

The contract information may include at least one of attribute information and the predetermined payment amount, the attribute information indicating attributes of contractors including the payer and the receiver.

The predetermined payment amount may include a payment amount based on a ratio of distribution.

The information processing apparatus may further include a generator that creates consensus information indicating the receiver's consensus with the contract information.

The transmitter may send the consensus information to the blockchain.

The information processing apparatus may further include a converter that converts one or more pieces of contract information into new single contract information.

The converter may convert first contract information related to a first person who pays a first payment amount and a second person who receives the first payment amount and second contract information related to the second person who pays a second payment amount and a third person who receives the second payment amount into third contract information related to the first person who pays the first payment amount, the second person who receives a difference amount of the second payment amount from the first payment amount, and the third person who receives the second payment amount.

The converter may convert first contract information related to a first person who pays a first payment amount and a second person who receives the first payment amount and second contract information related to the first person who pays a second payment amount and a third person who receives the second payment amount into third contract information related to the first person who pays a total payment amount of the first payment amount and the second payment amount, the second person who receives the first payment amount, and the third person who receives the second payment amount.

The encrypted contract information may include a zero-knowledge proof for proving validity of the contract information.

The consensus information may include a zero-knowledge proof indicating that the contract information has been correctly encrypted.

An information processing method according to an embodiment of the present technology is an information processing method executed by a computer system and includes sending, to a blockchain, contract information related to a payer who pays a predetermined payment amount and a receiver who receives the predetermined payment amount, the contract information having been encrypted.

Payment is automatically executed on the basis of the contract information.

A program according to an embodiment of the present technology causes a computer system to execute the following steps.

A step of sending, to a blockchain, contract information related to a payer who pays a predetermined payment amount and a receiver who receives the predetermined payment amount, the contract information having been encrypted.

A step of automatically executing payment on the basis of the contract information.

### BRIEF DESCRIPTION OF DRAWINGS

FIG. 1 A diagram schematically showing an information processing apparatus.

FIG. 2 A block diagram showing a configuration example of the information processing apparatus.

FIG. 3 A diagram showing a flow of a contract phase.

FIG. 4 A diagram showing remaining amount data.

FIG. 5 A diagram showing a flow of a payment phase.

FIG. 6 A diagram showing a plurality of pieces of contract information.

FIG. 7 A diagram showing a flow of a payment preparation phase.

FIG. 8 A diagram showing another flow of a contract phase.

FIG. 9 A diagram showing another flow of a payment phase.

FIG. 10 A diagram showing another flow of the payment preparation phase.

FIG. 11 A block diagram showing a hardware configuration example of the information processing apparatus.

### MODE(S) FOR CARRYING OUT THE INVENTION

Hereinafter, embodiments according to the present technology will be described with reference to the drawings.

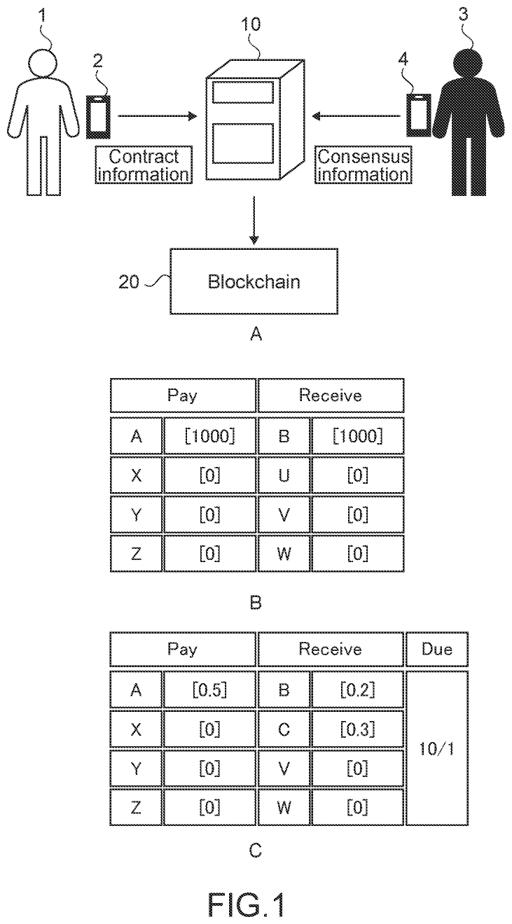

FIG. 1 is a diagram schematically showing an information processing apparatus according to the present technology. A of FIG. 1 is a diagram showing the overview of functions of the information processing apparatus.

As shown in A of FIG. 1, an information processing apparatus 10 acquires contract information related to a payer 1 who pays a predetermined payment amount and a receiver 3 who receives the predetermined payment amount. In the present embodiment, the payer 1 creates the contract information via a user terminal 2.

The contract information is information indicating who pays whom. In the present embodiment, the contract information includes at least one of attribute information and the predetermined payment amount. The attribute information indicates attributes of contractors including the payer and the receiver.

For example, in a contract where A having a remaining amount of 3,000 yen pays 1,000 yen to B, the contract information is as follows: A is the payer; B is the receiver; and the payment amount to be paid is 1,000 yen. It should be noted that in the present embodiment, information about the remaining amount of the payer and the receiver has been recorded on a blockchain.

It should be noted that the predetermined payment amount includes payment based on a ratio of distribution. That is, the predetermined payment amount includes a variable such as a profitability ratio of 5% in addition to a constant such as 1,000 yen. The predetermined payment amount includes a net income, sales revenue of 10%, etc. in addition to this. Numeric values and contents of the predetermined payment amount are not limited.

Moreover, the information processing apparatus 10 acquires, from the receiver 3 who has contracted with the payer 1, consensus information indicating consensus with the contract information acquired from the payer 1. For example, the consensus information is created in a case where the receiver 3 judges that the contract information has no problem as a result of checking the contract information via a user terminal 4.

The information processing apparatus 10 encrypts the acquired contract information and sends the encrypted contract information (hereinafter, referred to as contract data) to a blockchain 20.

The term “encryption” refers to a state (concealed state) in which the contract information cannot be known to other people excluding the payer and the receiver. That is, privacy protection can be achieved by encrypting the contract information. It should be noted that concealing the entire contract information and concealing a part of the contract information are both called encryption of the contract information.

B of FIG. 1 is a diagram showing the contract data.

For example, the information processing apparatus 10 acquires contract information, “A payer A pays 1,000 yen to a receiver B,” which has been created by the payer A. The information processing apparatus 10 encrypts a payment amount (Pay) of the contract information. It should be noted that [x (any number)] shown in B of FIG. 1 indicates that x has been encrypted with the payer's public key.

In the present embodiment, the information processing apparatus 10 samples dummy contractors U to Z whose payment amount is 0 yen. Accordingly, it is possible to make a contract in a state in which who the payer is and who the receiver is among A, B, and U to Z have been concealed and the anonymity has been secured, i.e., privacy has been protected. It should be noted that the contract data may include contract information related to those dummy contractors in addition to the encrypted contract information.

There is no limitations on the contents of the contract information. Any contract information may be set in accordance with the contract. The contract information may include, for example, the number of times of payment in a case where the predetermined payment amount is divided by n-times, a due date for payment, etc. Moreover, for example in a case where 50% of a seat reservation fee should be refunded if a particular condition that a bullet train or aircraft is delayed due to a typhoon or mechanical trouble is satisfied, the particular condition may be set as the contract information.

For example, functions realized by a smart contract or the like may be added other than this. Moreover, the contract information, e.g., the number of times and the due date, does not need to be concealed. Moreover, a plurality of contractors, e.g., a single payer and a large number of receivers, may be associated with the contract.

C of FIG. 1 is a diagram showing another example of the contract data. For example, C of FIG. 1 shows an example of the contract data including contract information other than the payers, the receivers, and the payment amount shown in B of FIG. 1. As shown in C of FIG. 1, the contract data indicates a contract, “The payer A pays 20% of revenue to the receiver B and pays 30% of revenue to a receiver C until 1st October.”

It should be noted that in a case where the ratio of distribution is used as the predetermined payment amount to be paid, a payment total amount may be randomized, for example.

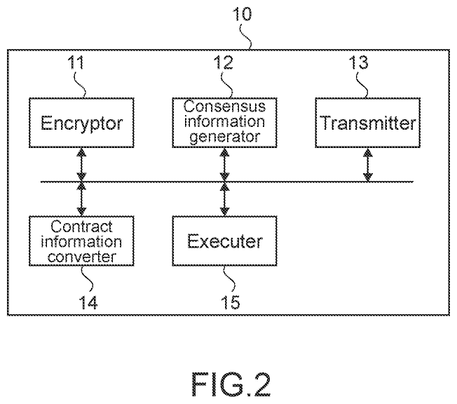

FIG. 2 is a block diagram showing a configuration example of the information processing apparatus 10.

As shown in FIG. 2, the information processing apparatus 10 includes an encryptor 11, a consensus information generator 12, a transmitter 13, a contract information converter 14, and an executer 15.

The encryptor 11 encrypts the contract information. It should be noted that an encryption method for the contract information is not limited. In the present embodiment, the encryptor 11 creates a zero-knowledge proof (ZKproof) indicating that the contract information is valid. Moreover, in the present embodiment, the contract data and the proof are provided to the transmitter 13.

The consensus information generator 12 creates consensus information with respect to the contract information checked by the receiver 3. In the present embodiment, on the basis of a creation request of a ZKproof (hereinafter, referred to as consensus ZKproof) indicating that the receiver 3 has agreed with the contract information, the consensus information generator 12 creates the consensus ZKproof. Moreover, in the present embodiment, the consensus proof created by the consensus information generator 12 is provided to the transmitter 13.

The transmitter 13 sends the contract data to the blockchain 20. In the present embodiment, the transmitter 13 sends, to the blockchain 20, the contract data and the proof created by the encryptor 11. Moreover, the transmitter 13 sends, to the blockchain 20, the consensus proof created by the consensus information generator 12.

The contract information converter 14 converts one or more pieces of contract information into new contract information. For example, the contract information converter 14 converts a contract where the payer A pays 1,000 yen to the receiver B and a contract where the payer B pays 700 yen to the receiver C into a contract where the payer A pays 300 yen to the receiver B and the payer A pays 700 yen to the receiver C.

Moreover, for example, a contract where the payer A pays 1,000 yen to the receiver B and a contract where the payer A pays 700 yen to the receiver C are converted into a contract where the payer A pays 1700 yen, the receiver B receives 1,000 yen, and the receiver C receives 700 yen.

That is, the contract information converter 14 is capable of combining a plurality of pieces of contract information so as to convert a contract where multi-step payment where A pays to B and B pays to C is performed into a new contract where A pays to B and C at once or so as to convert payment of a plurality of contracts that A pays to B and A pays to C into a new contract where A pays to B and C at once.

The executer 15 automatically executes payment on the basis of the contract information registered in the blockchain 20. In the present embodiment, the executer 15 sends, to the blockchain 20, payment total amount data indicating a total amount to be paid by the payer 1 and a ZKproof indicating that the remaining amount of the payer 1 is equal to or larger than the payment total amount.

It should be noted that the term “automatic” means that it does not require complicated operations related to the payment by the users (payer 1 and receiver 3) and the like. For example, it can be an operation of creating new contract information, an operation of registering it in the blockchain 20, an operation of performing payment based on the newly created contract information, and the like. In the present embodiment, in accordance with the information processing apparatus 10, the payment based on the contract is executed only by the payer 1 creating the contract information and executing the payment based on the contract.

It should be noted that the information processing apparatus 10 may perform the payment based on the contract (payment phase to be described later). For example, in a contract where the predetermined payment amount is paid when the due date has come, the information processing apparatus 10 may execute the payment based on the contract. As a matter of course, the payer 1 or the receiver 3 may set which one, the information processing apparatus 10 or the payer 1, performs the payment.

It should be noted that in the present embodiment, the consensus information generator 12 corresponds to a generator that creates consensus information indicating the receiver's consensus with the contract information.

It should be noted that in the present embodiment, the transmitter 13 corresponds to a transmitter that sends, to a blockchain, contract information related to a payer who pays a predetermined payment amount and a receiver who receives the predetermined payment amount, the contract information having been encrypted.

It should be noted that in the present embodiment, the contract information converter 14 corresponds to a converter that converts one or more pieces of contract information into new single contract information.

It should be noted that in the present embodiment, the executer 15 corresponds to an executer that automatically executes payment on the basis of the contract information.

### [Contract Phase]

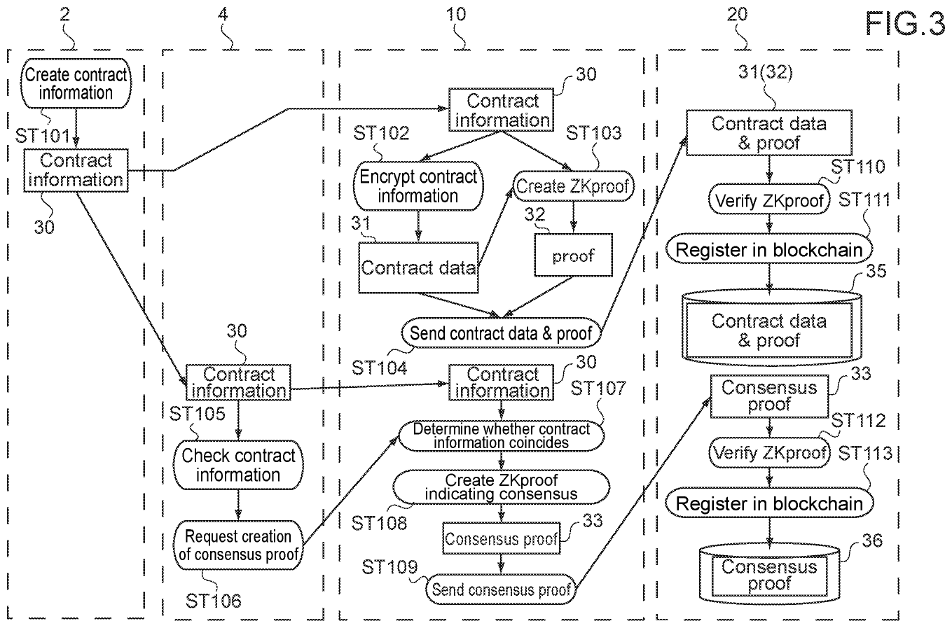

FIG. 3 is a diagram showing a flow of a contract phase (from creation of the contract data to registration of the blockchain 20). In the present embodiment, the information processing apparatus 10 generates secret keys and public keys for every contractor in advance and manages them inside. Moreover, in FIG. 3, these keys are also included in the encryption and the ZKproof generation as inputs depending on needs.

As shown in FIG. 3, the payer 1 creates contract information 30 via the user terminal 2 (Step 101). The payer 1 sends the contract information 30 to the information processing apparatus 10. Moreover, the payer 1 sends the contract information 30 in the form of a clear text to the user terminal 4 of the receiver 3 by off-chain.

The encryptor 11 encrypts the acquired contract information 30 (Step 102). Moreover, the encryptor 11 creates a ZKproof indicating that contract contents of contract data 31 are valid (Step 103).

The transmitter 13 sends the contract data 31 and a proof 32 to the blockchain 20 (Step 104).

The receiver 3 checks the contract information 30 created by the payer 1 (Step 105). The receiver 3 checks the contract information 30 and sends a creation request of a consensus proof to the information processing apparatus 10 (Step 106).

The consensus information generator 12 determines whether or not the contract information 30 sent from the payer 1 coincides with the contract information 30 sent from the receiver 3 (Step 107). In a case where the contract information 30 sent from the payer 1 coincides with the contract information 30 sent from the receiver 3, the consensus ZKproof is created (Step 108). Moreover, the transmitter 14 sends the created consensus proof 33 to the blockchain 20 (Step 109).

The blockchain 20 verifies the proof 32 sent from the transmitter 13 (Step 110). In a case where it has been successfully verified, the contract data 31 and the proof 32 are registered in a distributed ledger 35 of the blockchain 20 (Step 111). Moreover, the blockchain 20 verifies the consensus proof 33 sent from the consensus information generator 12 (Step 112). In a case where it has been successfully verified, the consensus proof 33 is registered in a distributed ledger 36 of the blockchain 20 (Step 113).

### [Payment Phase]

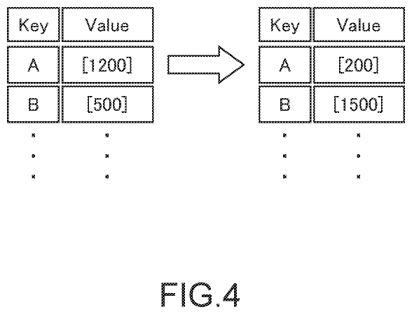

FIG. 4 is a diagram showing remaining amount data.

In the present embodiment, it is assumed that remaining amounts of the respective contractors in the form encrypted by additively homomorphic encryption have been recorded on the blockchain 20. For example, as shown in the left picture of FIG. 4, as the remaining amount data at the time of the contract, A's remaining amount of 1200 yen and B's remaining amount of 500 yen have been recorded on the blockchain.

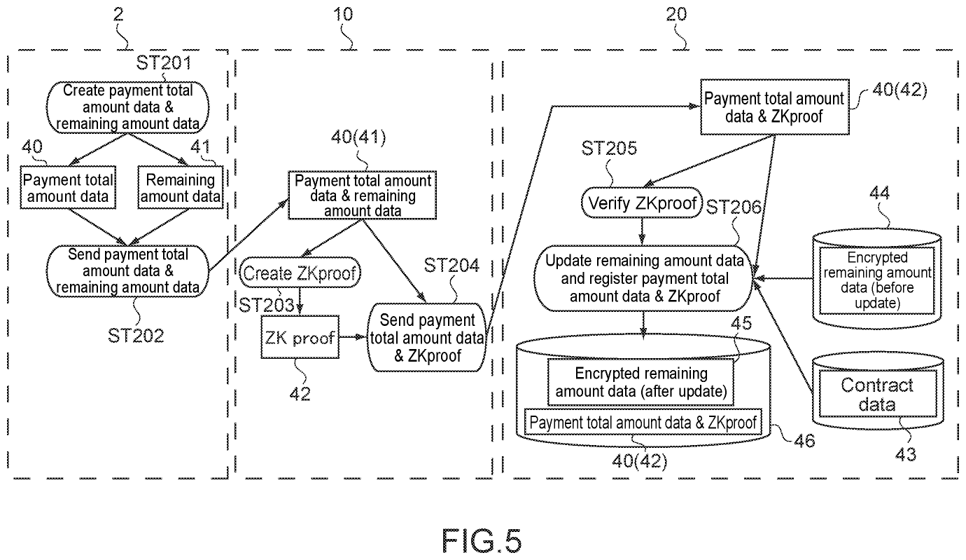

As shown in the right picture of FIG. 4, in a case where a contract where A pays 1,000 yen to B has been made, 1,000 yen is subtracted from the A's remaining amount and 1,000 yen is added to the B's remaining amount. Processing related to such payment will be described with reference to FIG. 5.

FIG. 5 is a diagram showing a flow of the payment phase (creation of the payment total amount data and the remaining amount data to update of the remaining amount).

As shown in FIG. 5, the payer 1 creates payment total amount data 40 and remaining amount data 41 via the user terminal 2 (Step 201). The payer 1 sends the payment total amount data 40 and the remaining amount data 41 to the information processing apparatus 10 (Step 202).

In the present embodiment, the executer 15 creates a ZKproof 42 indicating that the remaining amount of the payer 1 is equal to or larger than the payment total amount on the basis of the remaining amount data 41 (Step 203). Moreover, the executer 15 sends the payment total amount data 40 and the ZKproof 42 to the blockchain 20 (Step 204).

The blockchain 20 verifies the ZKproof 42 (Step 205). In a case where it has been successfully verified, a payment operation is executed (Step 206). In the present embodiment, the remaining amount data is updated and the payment total amount data and the ZKproof are registered. Moreover, in a case where it has failed to be verified, the payment operation is stopped.

Moreover, the blockchain 20 updates the remaining amount by adding an encrypted text of contract data 43 to the remaining amount (a distributed ledger 44) of each contractor. The updated encrypted remaining amount data 45 and the payment total amount data 40 and the ZKproof 42 are recorded on a distributed ledger 46.

That is, in the payment phase, directly adding the encrypted text of the contract data to the remaining amount enables the payment according to the contract to be performed.

### [Payment Preparation Phase]

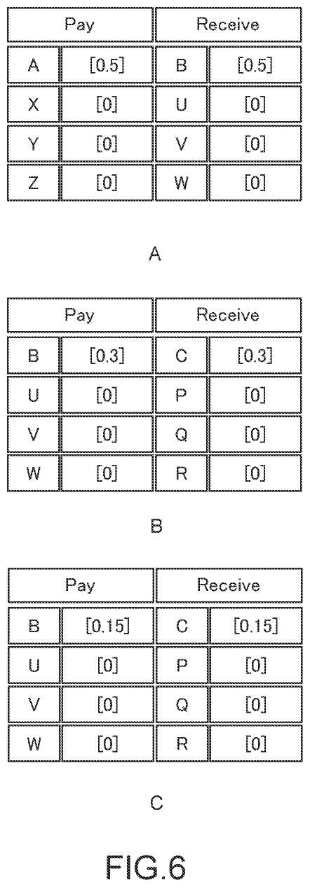

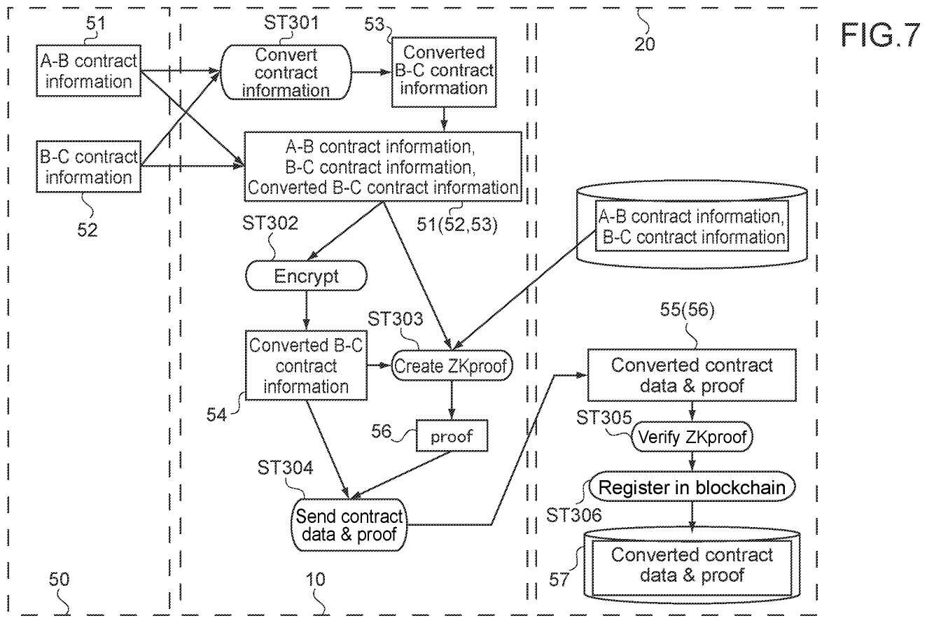

In FIGS. 3 and 5, the contract information related to the single payer and the single receiver has been described as an example. In FIGS. 6 and 7, a contract between the payer A and the receiver B and a contract between the payer B and the receiver C are described as an example. In the present embodiment, the contract information converter 14 is capable of combining a plurality of pieces of contract information by executing the flow shown in FIG. 7.

FIG. 6 is a diagram showing the plurality of pieces of contract information. A of FIG. 6 is a diagram showing contract data between the payer A and the receiver B. B of FIG. 6 is a diagram showing contract data between the payer B and the receiver C. C of FIG. 6 is a diagram showing new contract data obtained by converting the contract data between the payer B and the receiver C.

As shown in A of FIG. 6, contract data indicating contract information indicating a contract, “The payer A pays 50% of revenue to the receiver B” and sampled dummy contractors U to Z are shown.

As shown in B of FIG. 6, contract data indicating contract information indicating a contract, “The payer B pays 30% of revenue to the receiver C,” and samples dummy contractors P to R and U to W are shown. It should be noted that the revenue of the payer B in B of FIG. 6 refers to a payment total amount paid by the payer A.

The contract information converter 14 converts the contract data shown in B of FIG. 6 into the contract data shown in C of FIG. 6.

In the example in FIG. 6, the payment amount received by the receiver C is 15% because it is 30% of 50% of the A's payment total amount. That is, as shown in of FIG. 6, the contract information converter 14 converts the percent paid to C into 15%.

After the conversion, the payment is performed by executing the payment phase. It should be noted that the converted contract data is referenced during the payment.

FIG. 7 is a diagram showing a flow of a payment preparation phase (from conversion of the contract data to registration in the blockchain 20). It should be noted that in FIG. 7, the attribute information is omitted in some cases. For example, the contract between the payer A and the receiver B will be referred to as an A-B contract. Moreover, the same applies to the contract information. For example, in a case where B-C contract information is found, it refers to contract information related to the payer B and the receiver C.

As shown in FIG. 7, in the present embodiment, B sends A-B contract information 51 and B-C contract information 52 to the information processing apparatus 10 via a user terminal 50.

The contract information converter 14 converts the B-C contract information 52 on the basis of the A-B contract information 51 and the B-C contract information 52 (Step 301). In the present embodiment, the contract information converter 14 converts the B-C contract information 52 in a useful form that enables the payment to be performed at once while keeping the consistency to the A-B contract information 51.

The encryptor 11 encrypts converted B-C contract information 53 (Step 302). Moreover, the encryptor 11 creates a ZKproof indicating that no illegal operations have been made in the conversion and encryption (Step 303).

The transmitter 13 sends, to the blockchain 20, new contract data (hereinafter, referred to as converted contract data 55) obtained by the contract information converter 14 integrating the A-B contract information 51 and converted B-C contract data 54 and a proof 56 (Step 304).

The blockchain 20 verifies the proof 56 sent from the transmitter 13 (Step 305). In a case where it has been successfully verified, the converted contract data 55 and the proof 56 are registered in a distributed ledger 57 of the blockchain 20 (Step 306).

By executing the payment preparation phase shown in FIG. 7, the contract from B to C is automatically executed when the A-B contract is executed. That is, B does not need to execute the payment to C anew after the payment from A to B is executed. Moreover, executing the payment preparation phase once enables the payment to be repeatedly performed without limit thereafter. Thus, an action of performing the payment can be omitted, which can improve the usability.

### EXAMPLES

Examples to which the present technology can be applied will be described. It should be noted that in the following examples, x and x′ denote any number.

Payment of a use fee for a subscription service, e.g., “paying x yen per month,” can be one of the examples. For example, the payer is a user of the service and the receiver is a provider of the service. In this case, the payment is automatically executed by the contract phase and the payment phase.

Payment of a royalty for the copyright, e.g., “paying x % of revenue to a copyright holder,” can be one of the examples. In a case of music, a contract, “A company that performs a distribution service pays x % of revenue to a publisher,” and a contract, “The publisher pays x′% of revenue to an artist,” are assumed. In this case, a contract is made between the company and the publisher and a contract is made between the publisher and the artist during the contract phase and the publisher converts contract data in the contract preparation phase. By executing the payment phase thereafter, the payment from the company to the publisher and the artist is performed.

Payment of a royalty for the copyright associated with xth creation of content, e.g., “x % of the revenue is paid to an original creator,” can be one of the examples. For example, a contract, “A user of secondary creation content pays x % of the use fee to a secondary creator,” and a contract, “The secondary creator pays x′% of the use fee to the original creator,” are assumed. In this case, a contract is made between the user and the secondary creator and a contract is made between the secondary creator and the original creator and the secondary creator converts contract data in the contract preparation phase. By executing the payment phase thereafter, the payment from the user to the secondary creator and the original creator is performed.

Hereinabove, in the information processing apparatus 10 according to the present embodiment, the contract information related to the payer 1 who pays the predetermined payment amount and the receiver 3 who receives the predetermined payment amount is sent to the blockchain 20, the contract information having been encrypted. On the basis of the contract information, the payment is automatically executed. Accordingly, the payment can be automatically performed while protecting privacy of the contract information managed by the blockchain.

Conventionally, since the blockchain has characteristics that all participants copy and keep the same ledger, data on the blockchain is opened to all the participants, and there are limitations on use cases for privacy protection. Moreover, in a case where encryption technologies such as the zero-knowledge proof are used, only a simple payment function is used. Thus, it is difficult to use a smart contract that automatically executes contracts recorded on the blockchain.

In view of this, in the present technology, the contract information related to the payer who pays the predetermined payment amount and the receiver who receives the predetermined payment amount, which has been encrypted, is registered in the blockchain and the payment is automatically executed on the basis of the registered contract information. Accordingly, the payment can be automatically performed while protecting privacy of the contract information managed by the blockchain. Moreover, it is possible to flexibly cope with various use cases by using functions of the blockchain and the smart contract with privacy protected.

### OTHER EMBODIMENTS

The present technology is not limited to the above-mentioned embodiments, and various other embodiments can be realized.

In the above-mentioned embodiments, when the contract phase, the payment phase, and the payment preparation phase are executed, various types of data are sent to the blockchain 20 via the information processing apparatus 10. The present technology is not limited thereto, and various types of data may be sent to the blockchain 20 from the user terminals of the payer and the receiver. That is, the user terminals of the payer and the receiver may achieve the functions of the information processing apparatus 10.

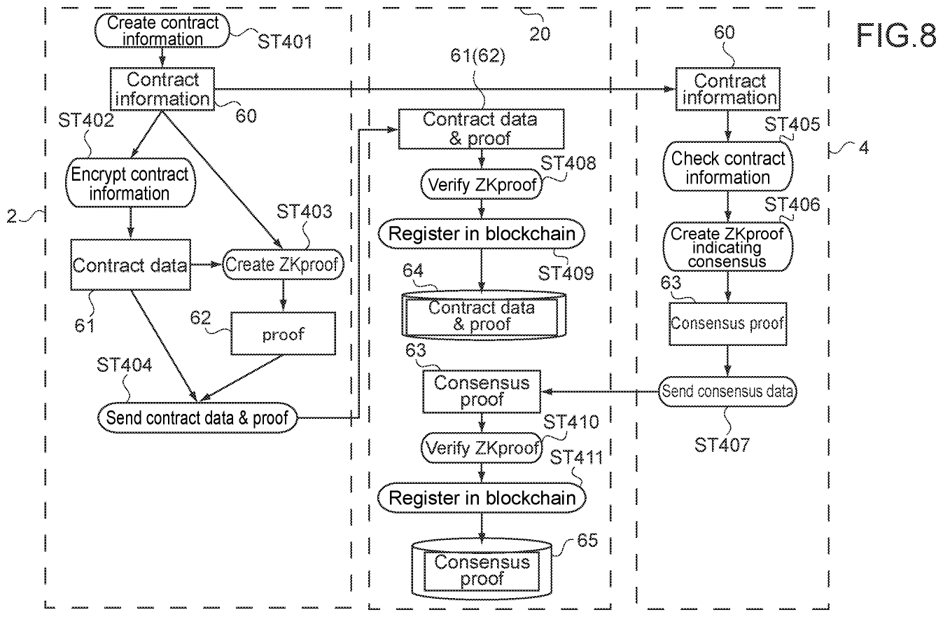

FIG. 8 is a diagram showing another flow of the contract phase. In the present embodiment, it is assumed that each contractor has generated a secret key and a public key via the contractor's terminal in advance and the public key has been opened to other contractors (party). Moreover, in FIG. 8, these keys are also included in the encryption and the ZKproof generation as inputs depending on needs.

As shown in FIG. 8, the payer 1 creates contract information 60 via the user terminal 2 (Step 401). Moreover, the payer 1 sends the contract information 60 in the form of a clear text to the user terminal 4 of the receiver 3 by off-chain.

The encryptor 11 encrypts the created contract information 60 (Step 402). Moreover, the encryptor 11 creates a ZKproof indicating that contract contents of contract data are valid (Step 403).

The transmitter 13 sends contract data 61 and a proof 62 to the blockchain 20 (Step 104).

The receiver 3 checks the contract information 60 created by the payer 1 (Step 405). In the present embodiment, the receiver 3 checks whether the contents of the contract information 60 are unarguable and whether the contract information 60 on the blockchain 20 is one obtained by correctly encrypting the contract information 60 received from the payer 1.

In a case where the contract information is correct, the consensus information generator 12 creates a consensus ZKproof (Step 406). The transmitter 13 sends a created consensus proof 63 to the blockchain 20 (Step 407).

The blockchain 20 verifies the proof 62 sent from the transmitter 13 (Step 408). In a case where it has been successfully verified, the contract data 61 and the proof 62 are registered in a distributed ledger 64 of the blockchain 20 (Step 409). Moreover, the blockchain 20 verifies the consensus proof 63 sent from the user terminal 4 (Step 410). In a case where it has been successfully verified, the consensus proof 63 is registered in a distributed ledger 65 of the blockchain 20 (Step 411).

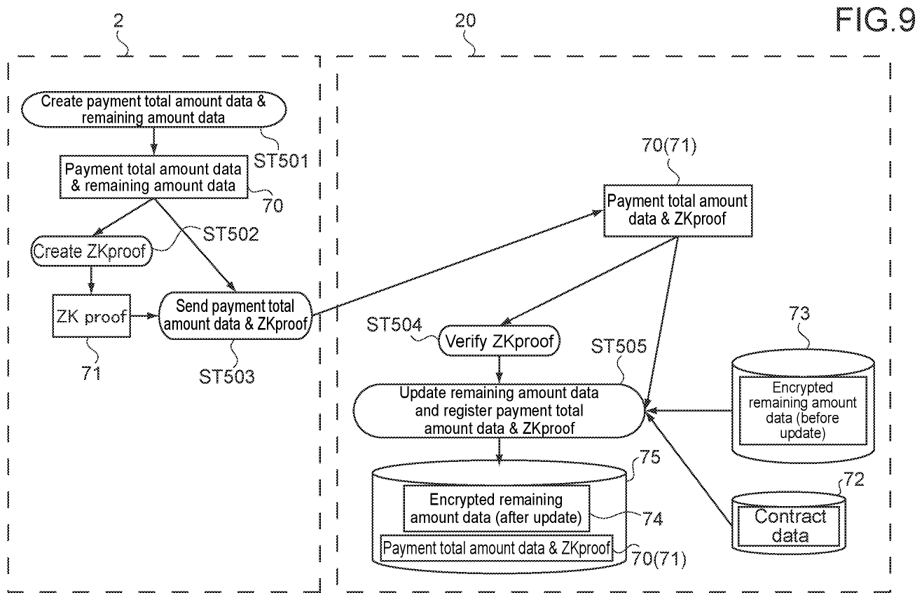

FIG. 9 is a diagram showing another flow of the payment phase.

As shown in FIG. 9, the payer 1 creates payment total amount data 70 and remaining amount data via the user terminal 2 (Step 501). The executer 15 creates a ZKproof indicating that the remaining amount of the payer 1 is equal to or larger than the payment total amount on the basis of the remaining amount data (Step 502). Moreover, the executer 15 sends the payment total amount data 70 and a ZKproof 71 to the blockchain 20 (Step 503).

The blockchain 20 verifies the ZKproof 71 (Step 504). In a case where it has been successfully verified, the payment operation is executed (Step 505). In the present embodiment, the remaining amount data is updated and the payment total amount data and the ZKproof are registered.

Moreover, the blockchain 20 updates the remaining amount by adding an encrypted text of contract data 72 to a remaining amount (distributed ledger 73) of each contractor. The updated encrypted remaining amount data 74 and the payment total amount data 70 and the ZKproof 71 are recorded on a distributed ledger 75.

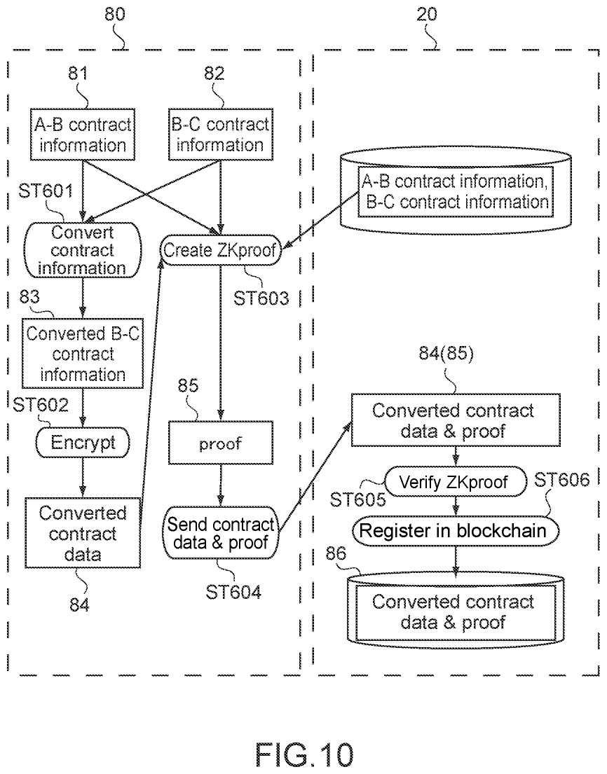

FIG. 10 is a diagram showing another flow of the payment preparation phase. It should be noted that in FIG. 10, the attribute information is omitted in some cases as in FIG. 7.

As shown in FIG. 10, the contract information converter 14 converts B-C contract information 82 on the basis of A-B contract information 81 and B-C contract information 82, which has been acquired by B's user terminal 80 (Step 601). In the present embodiment, the contract information converter 14 converts the B-C contract information 82 in a useful form that enables the payment to be performed at once while keeping the consistency to the A-B contract information 81.

The encryptor 11 encrypts the converted B-C contract information 82 (Step 602). Moreover, the encryptor 11 creates a ZKproof indicating that no illegal operations have been made in the conversion and encryption (Step 603).

The transmitter 13 sends, to the blockchain 20, new contract data (hereinafter, referred to as converted contract data 84) in which the A-B contract information 81 and converted B-C contract data 83 are integrated by the contract information converter 14 and a proof 85 (Step 604).

The blockchain 20 verifies the proof 85 sent from the transmitter 13 (Step 605). In a case where it has been successfully verified, the converted contract data 84 and the proof 85 are registered in a distributed ledger 86 of the blockchain 20 (Step 606).

In the above-mentioned embodiments, in the contract phase, the payment phase, and the payment preparation phase, the payment total amount data, the ZKproof, and the like are sent to the blockchain 20. The present technology is not limited thereto, and information required for the contract, the payment, and the like may be sent as appropriate. For example, information about random numbers used for the encryption and the like, which are required for the ZKproof when B performs the payment in FIG. 7, may be sent.

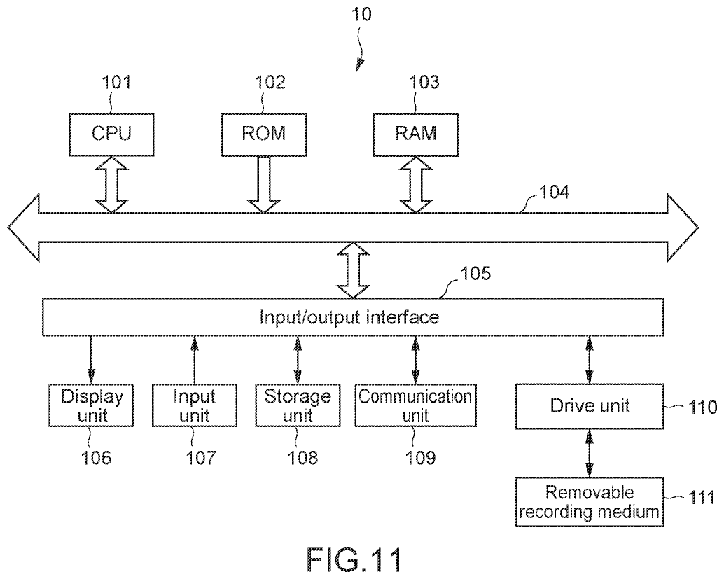

FIG. 11 is a block diagram showing a hardware configuration example of the information processing apparatus 10.

The information processing apparatus 10 includes a CPU 101, a ROM 102, a RAM 103, an input/output interface 105, and a bus 104 that connects them to one another. A display unit 106, an input unit 107, a storage unit 108, a communication unit 109, a drive unit 104, and the like are connected to the input/output interface 105.

The display unit 106 is, for example, a display device using liquid crystals, EL, or the like. The input unit 107 is, for example, a keyboard, a pointing device, a touch panel, or another operation device. In a case where the input unit 107 includes a touch panel, the touch panel can be integral with the display unit 106.

The storage unit 108 is a nonvolatile storage device. The storage unit 108 is, for example, an HDD, a flash memory, or another solid-state memory. The drive unit 104 is, for example, a device capable of driving a removable recording medium 111 such as an optical recording medium or a magnetic record tape.

The communication unit 109 is a modem, a router, or another communication device for communicating with other devices, which is connectable to a LAN, a WAN, or the like. The communication unit 109 may perform wired communication or may perform wireless communication. The communication unit 109 is often used separately from the information processing apparatus 10. In the present embodiment, the communication unit 109 is capable of communicating with another apparatus via a network.

Cooperation of software stored in the storage unit 108, the ROM 102, or the like with hardware resources of the information processing apparatus 10 achieves information processing of the information processing apparatus 10 having the hardware configurations as described above. Specifically, loading a program that configures the software, which has been stored in the ROM 102 or the like, to the RAM 103 and executing it achieves the information processing method according to the present technology.

The information processing apparatus 10 installs the program via the recording medium 111, for example. Alternatively, the information processing apparatus 10 may install the program via a global network or the like. Otherwise, any computer-readable non-transitory storage medium may be used.

Cooperation of a computer mounted on a communication terminal with another computer capable of communicating with it via a network or the like may execute the information processing apparatus, the information processing method, and the program according to the present technology and configure the information processing apparatus according to the present technology.

That is, the information processing apparatus, the information processing method, and the program according to the present technology may be performed not only in a computer system constituted by a single computer but also in a computer system in which a plurality of computers cooperatively operate. It should be noted that in the present disclosure, the system means a set of a plurality of components (e.g., apparatuses, modules (parts)) and it does not matter whether or not all the components are housed in the same casing. Therefore, both of a plurality of apparatuses housed in separate casings and connected to one another via a network and a single apparatus having a plurality of modules housed in a single casing are the system.

Executing the information processing apparatus, the information processing method, and the program according to the present technology by the computer system includes, for example, both of a case where a single computer executes encryption of the contract information, creation of the consensus information, conversion of the contract information, and the like, and a case where different computers execute the respective processes. Moreover, executing the respective processes by a predetermined computer includes causing another computer to execute some or all of those processes and acquiring the results.

That is, the information processing apparatus, the information processing method, and the program according to the present technology can also be applied to a cloud computing configuration in which a plurality of apparatuses shares and cooperatively processes a single function via a network.

The respective configurations such as the encryptor, the consensus information generator, and the contract information converter, the control flow of the communication system, and the like, which have been described with reference to the respective drawings, are merely embodiments, and can be arbitrarily modified without departing from the gist of the present technology. That is, any other configurations, algorithms, and the like for carrying out the present technology may be employed.

It should be noted that the effects described in the present disclosure are merely exemplary and not limitative, and further other effects may be provided. The description of the plurality of effects above does not necessarily mean that those effects are provided at the same time. It means that at least any one of the above-mentioned effects is obtained depending on a condition and the like, and effects not described in the present disclosure can be provided as a matter of course.

At least two features of the features of the above-mentioned embodiments may be combined. That is, the various features described in the respective embodiments may be arbitrarily combined across the respective embodiments.

It should be noted that the present technology can also take the following configurations.

(1) An information processing apparatus, including:
a transmitter that sends, to a blockchain, contract information related to a payer who pays a predetermined payment amount and a receiver who receives the predetermined payment amount, the contract information having been encrypted; and an executer that automatically executes payment on the basis of the contract information.
   (2) The information processing apparatus according to (1), in which
the contract information includes at least one of attribute information and the predetermined payment amount, the attribute information indicating attributes of contractors including the payer and the receiver.
   (3) The information processing apparatus according to (2), in which
the predetermined payment amount includes a payment amount based on a ratio of distribution.
   (4) The information processing apparatus according to (1), further including
a generator that creates consensus information indicating the receiver's consensus with the contract information.
   (5) The information processing apparatus according to (4), in which
the transmitter sends the consensus information to the blockchain.
   (6) The information processing apparatus according to (1), further including
a converter that converts one or more pieces of contract information into new single contract information.
   (7) The information processing apparatus according to (6), in which
the converter converts first contract information related to a first person who pays a first payment amount and a second person who receives the first payment amount and second contract information related to the second person who pays a second payment amount and a third person who receives the second payment amount into third contract information related to the first person who pays the first payment amount, the second person who receives a difference amount of the second payment amount from the first payment amount, and the third person who receives the second payment amount.
   (8) The information processing apparatus according to (6), in which
the converter converts first contract information related to a first person who pays a first payment amount and a second person who receives the first payment amount and second contract information related to the first person who pays a second payment amount and a third person who receives the second payment amount into third contract information related to the first person who pays a total payment amount of the first payment amount and the second payment amount, the second person who receives the first payment amount, and the third person who receives the second payment amount.
   (9) The information processing apparatus according to (1), in which
the encrypted contract information includes a zero-knowledge proof for proving validity of the contract information.
   (10) The information processing apparatus according to (4), in which
the consensus information includes a zero-knowledge proof indicating that the contract information has been correctly encrypted.
   (11) An information processing method executed by a computer system, including:
sending, to a blockchain, contract information related to a payer who pays a predetermined payment amount and a receiver who receives the predetermined payment amount, the contract information having been encrypted; and
automatically executing payment on the basis of the contract information.
   (12) A program that causes a computer system to execute:
a step of sending, to a blockchain, contract information related to a payer who pays a predetermined payment amount and a receiver who receives the predetermined payment amount, the contract information having been encrypted; and
a step of automatically executing payment on the basis of the contract information.

### REFERENCE SIGNS LIST

10 information processing apparatus
12 consensus information generator
13 transmitter
14 contract information converter
15 executer
20 blockchain

1. An information processing apparatus, comprising:
a transmitter that sends, to a blockchain, contract information related to a payer who pays a predetermined payment amount and a receiver who receives the predetermined payment amount, the contract information having been encrypted; and
an executer that automatically executes payment on a basis of the contract information.

2. The information processing apparatus according to claim 1, wherein
the contract information includes at least one of attribute information and the predetermined payment amount, the attribute information indicating attributes of contractors including the payer and the receiver.

3. The information processing apparatus according to claim 2, wherein
the predetermined payment amount includes a payment amount based on a ratio of distribution.

4. The information processing apparatus according to claim 1, further comprising
a generator that creates consensus information indicating the receiver's consensus with the contract information.

5. The information processing apparatus according to claim 4, wherein
the transmitter sends the consensus information to the blockchain.

6. The information processing apparatus according to claim 1, further comprising
a converter that converts one or more pieces of contract information into new single contract information.

7. The information processing apparatus according to claim 6, wherein
the converter converts first contract information related to a first person who pays a first payment amount and a second person who receives the first payment amount and second contract information related to the second person who pays a second payment amount and a third person who receives the second payment amount into third contract information related to the first person who pays the first payment amount, the second person who receives a difference amount of the second payment amount from the first payment amount, and the third person who receives the second payment amount.

8. The information processing apparatus according to claim 6, wherein
the converter converts first contract information related to a first person who pays a first payment amount and a second person who receives the first payment amount and second contract information related to the first person who pays a second payment amount and a third person who receives the second payment amount into third contract information related to the first person who pays a total payment amount of the first payment amount and the second payment amount, the second person who receives the first payment amount, and the third person who receives the second payment amount.

9. The information processing apparatus according to claim 1, wherein
the encrypted contract information includes a zero-knowledge proof for proving validity of the contract information.

10. The information processing apparatus according to claim 4, wherein
the consensus information includes a zero-knowledge proof indicating that the contract information has been correctly encrypted.

11. An information processing method executed by a computer system, comprising:
sending, to a blockchain, contract information related to a payer who pays a predetermined payment amount and a receiver who receives the predetermined payment amount, the contract information having been encrypted; and
automatically executing payment on a basis of the contract information.

12. A program that causes a computer system to execute:
a step of sending, to a blockchain, contract information related to a payer who pays a predetermined payment amount and a receiver who receives the predetermined payment amount, the contract information having been encrypted; and
a step of automatically executing payment on a basis of the contract information.
